(19) United States
(12) Patent Application Publication
(10) Pub. No.: US 2023/0141870 A1
(43) Pub. Date: May 11, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventor: EISUKE NOMURA, TOKYO (JP)

(21) Appl. No.: 17/906,349

(22) PCT Filed: Mar. 10, 2021
(86) PCT No.: PCT/JP2021/009507

§ 371 Date: Sep. 15, 2022

(30) Foreign Application Priority Data
Mar. 25, 2020 (JP) 2020-054460

(51) Int. Cl. G06T 19/00; G06V 10/74; G02B 27/01

(52) U.S. Cl. CPC G06T 19/006; G06V 10/761; G02B 27/0172; G02B 2027/0178

(57) ABSTRACT

An information processing apparatus according to the present technology includes: a control unit. The control unit causes a first display unit of a head-mounted display to display a virtual object in an augmented reality (AR) manner, detects a user interaction with regard to the virtual object, the interaction being performed with an interaction device, and causes a second display unit of the interaction device to display an image relating to the virtual object in accordance with the interaction.

### TECHNICAL FIELD

The present technology relates to a technology for presenting a virtual object displayed in an augmented reality (AR) manner to a user.

### BACKGROUND ART

In recent years, an augmented reality (AR) technology for superimposing and displaying a virtual object in a real space in the real world has become widely known.

For example, the following Patent Literature 1 describes a head-mounted display equipped with an AR technology. When a virtual object is AR-displayed while a user wears a head-mounted display, it is possible to make the user perceive the virtual object as if it were a real object present in the real space.

### CITATION LIST

### Patent Literature

Patent Literature 1: Japanese Patent Application Laid-open No. 2017-120550

### DISCLOSURE OF INVENTION

### Technical Problem

In such a field, there is a demand for a new method of presenting a virtual object that can be displayed on a head-mounted display to a user.

In view of the circumstances as described above, there is provided a new method of presenting a virtual object that can be displayed on a head-mounted display to a user.

### Solution to Problem

An information processing apparatus according to the present technology includes: a control unit. The control unit causes a first display unit of a head-mounted display to display a virtual object in an augmented reality (AR) manner, detects a user interaction with regard to the virtual object, the interaction being performed with an interaction device, and causes a second display unit of the interaction device to display an image relating to the virtual object in accordance with the interaction.

As a result, it is possible to provide a new method of presenting a virtual object that can be displayed on a head-mounted display to a user.

In the information processing apparatus, the interaction device may include an imaging unit, and the control unit may AR-display the virtual object on the second display unit and detect, as the interaction, an operation of imaging the AR-displayed virtual object by the imaging unit.

In the information processing apparatus, the control unit may detect, as the interaction, an operation of bringing the interaction device closer to the virtual object.

In the information processing apparatus, the operation of bringing may be an operation of holding the interaction device over the virtual object.

In the information processing apparatus, the control unit may change the interaction in accordance with a distance between a user wearing a head-mounted display and the AR-displayed virtual object.

In the information processing apparatus, the control unit may detect, where the distance between the user and the virtual object exceeds a predetermined threshold value, the operation of imaging as the interaction.

In the information processing apparatus, the control unit may detect, where the distance between the user and the virtual object is the predetermined threshold value or less, the operation of bringing as the interaction.

In the information processing apparatus, the control unit may detect, where the distance between the user and the virtual object is the predetermined threshold value or less, both the operation of bringing and the operation of imaging as the interaction.

In the information processing apparatus, the control unit may AR-display a reminding user interface for reminding the user of the interaction at a position corresponding to the virtual object in the first display unit.

In the information processing apparatus, the control unit may adjust, where a plurality of the reminding user interfaces is AR-displayed on the first display unit and a display area of the reminding user interface overlaps with a display area of another reminding user interface, the AR-display position of the reminding user interface.

In the information processing apparatus, the control unit may hide, where a display area of the virtual object AR-displayed on the first display unit overlaps with the second display unit, the virtual object in an area overlapping with the second display unit.

In the information processing apparatus, the control unit may hide, where a display area of the virtual object AR-displayed on the first display unit overlaps with the second display unit, an entire corresponding virtual object.

In the information processing apparatus, the control unit may cause, where a plurality of the virtual objects has been AR-displayed on the second display unit, the second display unit to AR-display a selection user interface for causing the user to select a virtual object to be imaged.

In the information processing apparatus, the interaction device may be a mobile device that can be held by the user or a wearable device that can be worn by a hand or an arm of the user.

An information processing method according to the present technology includes: causing a first display unit of a head-mounted display to AR-display a virtual object; detecting a user interaction with regard to the virtual object, the interaction being performed with an interaction device; and causing a second display unit of the interaction device to display an image relating to the virtual object in accordance with the interaction.

A program according to the present technology causes a computer to execute the following processing of: causing a first display unit of a head-mounted display to AR-display a virtual object; detecting a user interaction with regard to the virtual object, the interaction being performed with an interaction device; and causing a second display unit of the interaction device to display an image relating to the virtual object in accordance with the interaction.

### BRIEF DESCRIPTION OF DRAWINGS

FIG. 1 is a diagram showing an information processing system according to a first embodiment of the present technology.

FIG. 2 is a block diagram showing an internal configuration of the information processing system.

FIG. 3 is a diagram showing processing such as AR-display by an HMD.

FIG. 4 is a flowchart showing processing when an interaction has been performed with regard to a virtual object.

FIG. 5 is a flowchart showing processing of determining whether or not a virtual object has been imaged by a smartphone.

FIG. 6 is a flowchart showing processing of determining whether or not an imaging mode has been selected by a user.

FIG. 7 is a flowchart showing processing when a virtual object is hidden as necessary in the HMD.

FIG. 8 is a diagram showing an example when a holding-over UI has been AR-displayed for a virtual object.

FIG. 9 is a diagram showing an example when an imaging UI has been AR-displayed for a virtual object.

FIG. 10 is a diagram showing an example of a selection UI.

FIG. 11 is a diagram showing an example in the case where a virtual object AR-displayed by the HMD and a virtual object AR-displayed by a smartphone look unnatural.

FIG. 12 is a diagram showing an example in the case where an overlapping area between a virtual object and a display unit of the smartphone has been hidden in a display unit of the HMD.

FIG. 13 is a diagram showing an example in the case where the entire virtual object overlapping with the display unit of the smartphone has been hidden in an imaging mode.

### MODE(S) FOR CARRYING OUT THE INVENTION

Hereinafter, embodiments according to the present technology will be described with reference to the drawings.

### First Embodiment

<Entire Configuration and Configurations of Respective Units>

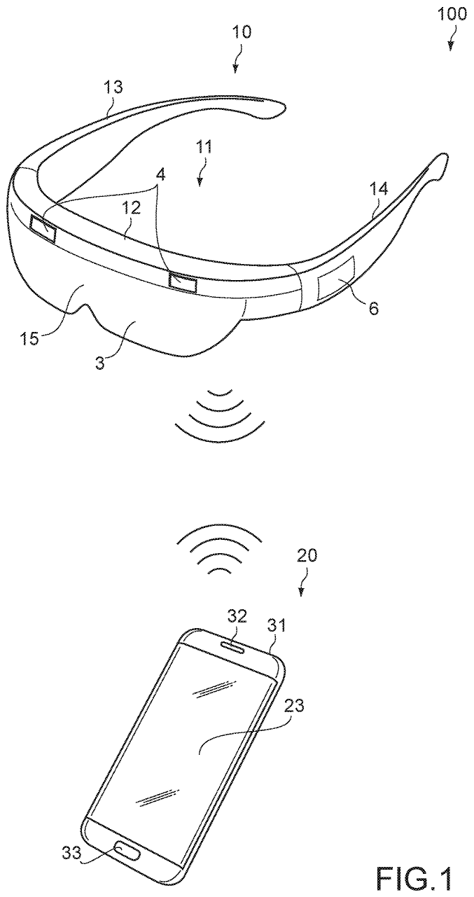

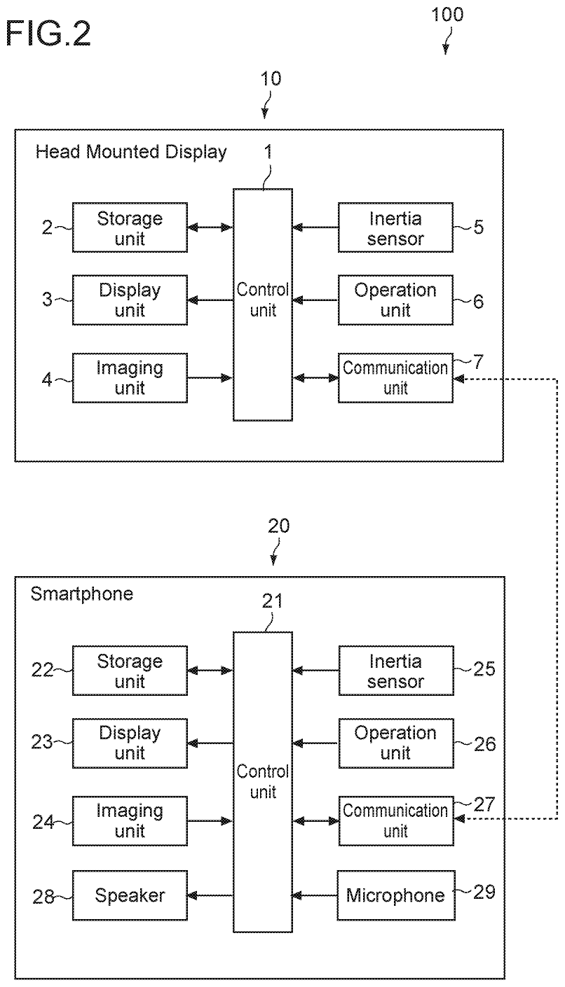

FIG. 1 is a diagram showing an information processing system 100 according to a first embodiment of the present technology. FIG. 2 is a block diagram showing an internal configuration of the information processing system 100.

As shown in FIG. 1 and in FIG. 2, the information processing system 100 according to the first embodiment includes an HMD (head Mounted Display) 10 and a smartphone (interaction device) 20.

As shown in FIG. 1 and FIG. 2, the HMD 10 includes an HMD body 11, a control unit 1, a storage unit 2, a display unit 3, an imaging unit 4, an inertia sensor 5, an operation unit 6, and a communication unit 7.

The HMD body 11 is attached to the head of a user and used. The HMD body 11 includes a front portion 12, a right temple portion 13 provided on the right side of the front portion 12, a left temple portion 14 provided on the left side of the front portion 12, and a glass portion 15 attached to the lower side of the front portion 12.

The display unit 3 is a see-through type display unit and is provided on the surface of the glass portion 15. The display unit 3 performs AR-display of a virtual object 30 in accordance with the control of the control unit 1. Note that the display unit 3 may be a non-see-through type display unit. In this case, AR-display is performed by displaying, on the display unit 3, an image obtained by superimposing the virtual object 30 on the image currently taken by the imaging unit 4.

The imaging unit 4 is, for example, a camera, and includes an image sensor such as a CCD (Charge Coupled Device) sensor and a CMOS (Complemented Metal Oxide Semiconductor) sensor and an optical system such as an image forming lens. The imaging unit 4 is provided outward on the outer surface of the front portion 12, images an object present in the line-of-sight direction of a user, and outputs image information obtained by the imaging to the control unit 1. Two imaging units 4 are provided in the front portion 12 at predetermined intervals in the lateral direction. Note that the place where the imaging unit 4 is provided and the number of the imaging units 4 can be changed as appropriate.

The inertia sensor 5 includes an acceleration sensor that detects the acceleration in the three-axis direction and an angular velocity sensor that detects the angular velocity around the three axes. The inertia sensor 5 outputs, to the control unit 1, the acceleration in the three-axis direction and the angular velocity around the three axes obtained by the detection as inertial information.

In this embodiment, the detection axes of the inertia sensor 5 are three axes, but the detection axes may be one axis or two axes. Further, in this embodiment, although two types of sensors are used as the inertia sensor 5, but one type or three or more types of sensors may be used as the inertia sensor 5. Note that other examples of the inertia sensor 5 include a speed sensor and an angle sensor. The same applies also to an inertia sensor 25 of the smartphone 20.

The operation unit 6 is, for example, an operation unit of various types such as a pressing type and a proximity type, detects an operation by the user, and outputs the detected operation to the control unit 1. Although the operation unit 6 is provided on the front side of the left temple portion 14 in the example shown in FIG. 1, the position where the operation unit 6 is provided may be any position as long as it is easy for the user to operate.

The communication unit 7 wired or wirelessly communicates with the smartphone 20 or an external device (e.g., a PC (Personal computer) or a server apparatus on the network) other than the smartphone 20.

The control unit 1 executes various operations on the basis of various programs stored in the storage unit 2 and integrally controls the respective units of the HMD 10. Note that the processing of the control unit 1 will be described below in detail in the column of description of operation.

The control unit 1 is realized by hardware or a combination of hardware and software. The hardware is configured as part or all of the control unit 1. Examples of this hardware include a CPU (Central Processing Unit), a GPU (Graphics Processing Unit), a DSP (Digital Signal Processor), an FPGA (Field Programmable Gate Array), an ASIC (Application Specific Integrated Circuit), and a combination of two or more of them. The same applies also to a control unit 21 in the smartphone 20.

The storage unit 2 includes a non-volatile memory for storing various programs necessary for processing of the control unit 1 and various types of data, and a volatile memory used as a work area of the control unit 1. Note that the various programs may be read from a portable recording medium such as an optical disk and a semiconductor memory or may be downloaded from a server apparatus on the network.

The smartphone 20 includes a casing 31, the control unit 21, a storage unit 22, a display unit 23, an imaging unit 24, the inertia sensor 25, an operation unit 26, a communication unit 27, a speaker 28, and a microphone 29.

The casing 31 has a size that a user can hold it with one hand. The display unit 23 is provided on the front surface of the casing 31, and an earpiece 32 is provided on the front surface of the casing 31 at a position above the display unit 23. Further, a push-button-type operation unit 33 is provided on the front surface of the casing 31 at a position below the display unit 23. Note that although not shown, a telephone port, a connector, and the like are also provided on the casing 31.

The display unit 23 includes, for example, a liquid crystal display or an EL (Electro-Luminescence) display. The display unit 23 displays various images on a screen in accordance with the control of the control unit 21.

The imaging unit 24 is, for example, a camera and includes an image sensor such as a CCD sensor and a CMOS sensor and an optical system such as an image forming lens. The imaging unit 24 is provided toward the back surface side of the casing 31, images an object present on the back surface side of the casing, and outputs the image information obtained by the imaging to the control unit 21.

The inertia sensor 25 includes an acceleration sensor that detects the acceleration in the three-axis direction and an angular velocity sensor that detects the angular velocity around the three axes. The inertia sensor 25 outputs, to the control unit 21, the acceleration in the three-axis direction and the angular velocity around the three axes obtained by the detection as inertial information.

The operation unit 26 includes, for example, the push-button-type operation unit 33, a proximity sensor provided in the display unit 23, and the like. The operation unit 26 detects an operation of a user and outputs the detected operation to the control unit 21.

The communication unit 27 performs communication for calls with another telephone. Further, the communication unit 27 wired or wirelessly communicates with the HMD 10 and an external device (a PC or a server apparatus on the network) other than the HMD 10.

The speaker 28 includes a digital/analog converter, an amplifier, and the like. The speaker 28 executes digital/analog conversion processing and amplification processing on the voice data for a call input from the control unit 21 and outputs the voice through the earpiece 32.

The microphone 29 includes an analog/digital converter and the like. The microphone 29 converts the analog voice data input from the user via the telephone port into digital voice data and outputs the obtained digital voice data to the control unit 21. The digital voice data output to the control unit 21 is encoded and then transmitted via the communication unit 27.

The control unit 21 executes various operations on the basis of various programs stored in the storage unit 22 and integrally controls the respective units of the smartphone 20. Note that the processing of the control unit 21 will be described below in detail in the column of description of operation.

The storage unit 22 includes a non-volatile memory for storing various programs necessary for processing of the control unit 21 and various types of data, and a volatile memory used as a work area of the control unit 21. Note that the various programs may be read from a portable recording medium such as an optical disk and a semiconductor memory or may be downloaded from a server apparatus on the network.

<Method in this Embodiment>

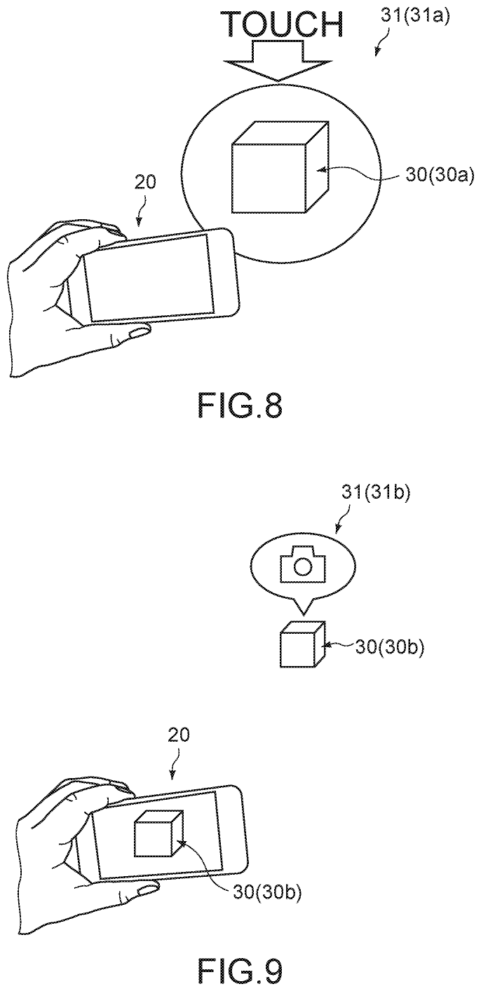

Next, a method of presenting the virtual object 30 used in this embodiment to a user will be briefly described (see FIG. 8 and FIG. 9 for the virtual object 30).

In the HMD 10, in the case where AR-display of the virtual object 30 is performed, normally, the position in the real world where the virtual object 30 is localized is often determined in advance. Therefore, in the case where a user wearing the HMD 10 is interested in a certain virtual object 30 and wants to know the virtual object 30 in detail, he/she needs to stay there and keep looking at the direction of the virtual object 30.

Further, currently, HMDs are already on the market, but the resolution of AR-display is often low and is often not suitable for taking a closer look at the virtual object 30 that the user is interested in.

For this reason, in this embodiment, a new method of presenting the virtual object 30 that can be AR-displayed on the HMD 10 to a user is provided. Typically, in this embodiment, a method of displaying, in the case where an interaction has been performed with the smartphone 20 with regard to the virtual object 30 that can be AR-displayed on the HMD 10, (an image relating to) the virtual object 30 on the smartphone 20 is used.

In this method, by performing, when the user wearing the HMD 10 is interested in the virtual object 30, an interaction with the smartphone 20 with regard to the virtual object 30, (an image relating to) the virtual object 30 is displayed on the smartphone 20. Therefore, the user does not need to stay there and keep looking at the virtual object 30 with the HMD 10. Further, currently, the smartphone 20 often has a higher resolution than the HMD 10 and thus is suitable for taking a closer look at the virtual object 30 that the user is interested in.

<Description of Operation>

Next, the processing of the control unit 1 of the HMD 10 and the control unit 21 of the smartphone 20 will be described. In the description here, first, the self-position estimation by the HMD 10 and the smartphone 20 and the common coordinate system in the self-position estimation will be described.

“Self-Position Estimation and Common Coordinate System”

After activation, the control unit 1 of the HMD 10 estimates the self-position and posture by SLAM (Simultaneous Localization And Mapping) on the basis of image information from the imaging unit 4 and inertial information from the inertia sensor 5. Similarly, after activation, the control unit 21 of the smartphone 20 estimates the self-position and posture by SLAM (Simultaneous Localization And Mapping) on the basis of image information from the imaging unit 24 and inertial information from the inertia sensor 25.

In the description here, a case where both the image information and the inertial information are used for the estimation of the self-position and posture has been described, one of the image information and the inertial information may be used for the estimation of the self-position and posture.

Further, after activation, the control unit 1 of the HMD 10 estimates the position and posture of the head of the user (head tracking).

In this case, the control unit 1 of the HMD 10 estimates the position and posture of the head of the user by adding, to the position and posture of the HMD 10, the offset amount between the position of the HMD 10 and the center position of the head of the user. For example, an average value obtained by a test for a plurality of users executed in advance is used as the offset amount between the position of the HMD 10 and the center position of the head of the user, and this average value is stored in the storage unit as the offset amount.

Note that the position and posture of the HMD 10 may be used as it is as the position and posture of the head of the user assuming that the position and posture of the head of the user is substantially the same as the position and posture of the HMD 10.

In this embodiment, in order to express the position and posture of each of the HMD 10, the smartphone 20, and the head of the user with the common coordinate system and express the relative position and posture, the following 1. to 3. methods are used alone or two or more of them are used in combination.

1. The Localize function of SLAM is used. The HMD 10 and the smartphone 20 each hold Map data that describes three-dimensional information in a real space, and the Map data is represented by the common coordinate system (the respective pieces of Map data are the same or part of the respective Map data is common). The HMD 10 and the smartphone 20 each estimate the self-position and posture using the Map data. In this case, a coordinate system defined in an arbitrary place in a real space recorded in the Map data is a common coordinates system.

2. By imaging, by the imaging unit 4 or 24 of one of the HMD 10 and the smartphone 20, the other device, the one device estimates the relative position and posture of the other device relative to the one device itself. In this case, the coordinate system of the one device that estimates the relative position and posture is the common coordinate system. Note that in order to make it easier to recognize the position and posture of the other device relative to the one device, an image-recognizable feature point (e.g., an infrared LED pattern (LED: Light Emitting Diode) that emits light by itself) or an object-recognizable texture) may be provided to the other device.

3. The HMD 10 and the smartphone 20 each image the feature point (e.g., a marker or a landmark) disposed in a real space by the imaging unit 4 or 24 to estimate the position and posture relative to the feature point. In this case, the coordinate system defined in the feature point is a common coordinate system. Note that in the case where the relative position and posture between a plurality of feature points are known, a plurality of feature points may be disposed in a real space.

“Interaction”

Next, processing relating to an interaction with regard to the virtual object 30 with the smartphone 20 will be described.

[AR-display by HMD 10, etc.]

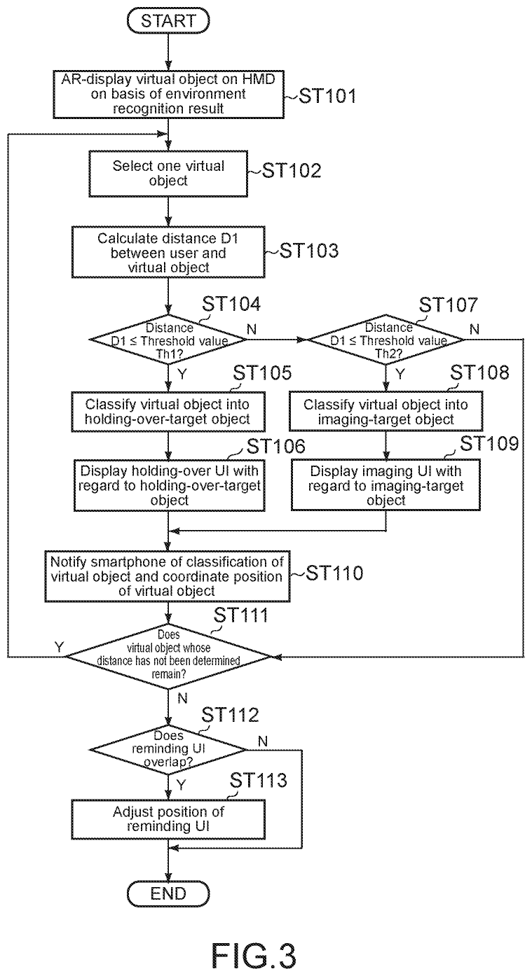

In the description here, first, processing such as AR-display by the HMD 10 will be described. FIG. 3 is a diagram showing processing such as AR-display by the HMD 10. Note that the processing shown in FIG. 3 is executed by the control unit 1 of “the HMD 10”.

First, the control unit 1 of the HMD 10 recognizes, on the basis of image information obtained by imaging by the imaging unit 4 of the HMD 10, the surrounding environment of the HMD 10 and AR-displays the virtual object 30 on the display unit 3 of the HMD 10 on the basis of the environment recognition result (Step 101).

Note that the phrase “AR-display the virtual object 30” on the HMD 10 means that the virtual object 30 is displayed on the display unit 3 of the HMD 10 thereby making the user perceive the virtual object 30 as if it were a real object present in the real space (the same applies to AR-display of a reminding UI 31 described below).

For the AR-display method in the HMD 10, a location-based AR may be used or a vision-based AR may be used. Alternatively, a combination of a location-based AR and a vision-based AR may be used.

In the location-based AR, the control unit 1 of the HMD 10 AR-displays the virtual object 30 on the basis of information of a GPS (Global Positioning System), an inertia sensor, or the like. In the vision-based AR, the control unit 1 of the HMD 10 recognizes the real space in front of the HMD 10 on the basis of image information obtained by imaging by the imaging unit 4 of the HMD 10 to AR-display the virtual object 30. As the vision-based AR, a marker-type vision-based AR may be used or a markerless-type vision-based AR may be used.

In the case where the marker-type vision-based AR is used, an AR marker is disposed in a real space and this AR marker is recognized by the HMD 10 to AR-display the virtual object 30 at the position corresponding to the AR marker. Meanwhile, in the case where the markerless-type vision-based AR is used, an object present in a real space is recognized and the virtual object 30 is AR-displayed with regard to the recognized object.

When virtual objects 30 are AR-displayed on the display unit 3 of the HMD 10, the control unit 1 of the HMD 10 selects one virtual object 30 from AR-displayed virtual objects 30 (Step 102). Then, the control unit 1 of the HMD 10 calculates a distance D1 between the user (head) and the selected virtual object 30 (Step 103).

Next, the control unit 1 of the HMD 10 determines whether or not the distance D1 between the user (head) and the virtual object 30 is equal to or less than a first threshold value Th1 (Step 104). In the case where the distance D1 is equal to or less than the first threshold value Th1 (YES in Step 104), i.e., the distance between the user and the virtual object 30 is short, the control unit 1 of the HMD 10 classifies the virtual object 30 into a holding-over-target object 30a (Step 105). The holding-over-target object 30a is the virtual object 30 that is the target of the interaction of holding the smartphone 20 over.

Next, the control unit 1 of the HMD 10 AR-displays, as the reminding UI 31 (UI: User Interface), a holding-over UI 31a on the display unit 3 of the HMD 10 at the position corresponding to the holding-over-target object 30a (Step 106).

Here, the reminding UI 31 is a UI AR-displayed on the display unit 3 of the HMD 10 at the position corresponding to the virtual object 30 and is a UI for reminding the user of interaction with regard to the virtual object 30 with the smartphone 20.

The holding-over UI 31a is a kind of reminding UI 31 and is an UI that reminds the user to hold the smartphone 20 over the virtual object 30 (the holding-over-target object 30a).

FIG. 8 is a diagram showing an example when the holding-over UI 31a has been AR-displayed for the virtual object 30 (the holding-over-target object 30a). The holding-over UI 31a shown in FIG. 8 includes a sphere that surrounds a cubic virtual object 30 (holding-over-target object 30a), a downward arrow located above the sphere, and a text of “TOUCH” located above the arrow. Note that the holding-over UI 31a may be in any form as long as it is possible to remind the user to hold the smartphone 20 (interaction device) over the virtual object 30.

Returning to FIG. 3, in Step 104, in the case where the distance D1 between the user (head) and the virtual object 30 exceeds the first threshold value Th1 (NO in Step 104), i.e., in the case where the distance between the user and the virtual object 30 is long, the control unit 1 of the HMD 10 proceeds to Step 107. In Step 107, the control unit 1 of the HMD 10 determines whether or not the distance D1 between the user (head) and the virtual object 30 is equal to or less than a second threshold value Th2.

In the case where the distance D1 is equal to or less than the second threshold value Th2 (YES in Step 107), the control unit 1 of the HMD 10 classifies the virtual object 30 into an imaging-target object 30b (Step 108). The imaging-target object 30b is the virtual object 30 that is the target of an interaction of imaging by the smartphone 20.

Next, the control unit 1 of the HMD 10 AR-displays an imaging UI 31b on the display unit 3 of the HMD 10 at the position corresponding to the imaging-target object 30b (Step 109). The imaging UI 31b is a kind of reminding UI 31 and is a UI that reminds the user to image the virtual object 30 (imaging-target object 30b) by the smartphone 20.

FIG. 9 is a diagram showing an example when the imaging UI 31b has been AR-displayed for the virtual object 30 (imaging-target object 30b). The imaging UI 31b shown in FIG. 9 includes a balloon located above the cubic virtual object 30 (imaging-target object 30b) and a mark of a camera located inside the balloon. Note that the imaging UI 31b may be in any form as long as it is possible to remind the user to image the virtual object 30 with the smartphone 20 (interaction device).

Returning to FIG. 3, after AR-displaying the holding-over UI 31a or the imaging UI 31b with regard to the virtual object 30 (Step 106 or 109), the control unit 1 of the HMD 10 proceeds to the next Step 110. In Step 110, the control unit 1 of the HMD 10 notifies the smartphone 20 of the classification of the virtual object 30 (the holding-over-target object 30a or the imaging-target object 30b) and the coordinate position of the virtual object 30.

After notifying the smartphone 20 of these pieces of information, the control unit 1 of the HMD 10 proceeds to the next Step 111. Similarly, in the case where the distance D1 between the user (head) and the virtual object 30 exceeds the second threshold value Th2 in Step 107, the control unit 1 of the HMD 10 the processing proceeds to Step 111 without executing classification and processing regarding the reminding UI 31 with regard to the virtual object 30.

That is, in this embodiment, of the virtual objects 30 AR-displayed on the HMD 10, the virtual object 30 that is too far from the user is not classified into either the holding-over-target object 30a or the imaging-target object 30b and the reminding UI 31 is not displayed. Note that all the virtual objects 30 having the distance D1 exceeding the first threshold value Th1 can be classified into the imaging-target object 30b.

Note that in the following description, of the virtual objects 30 AR-displayed on the HMD 10, the virtual object 30 that is not classified into either the holding-over-target object 30a or the imaging-target object 30b will be referred to as the unclassified virtual object. In this embodiment, this unclassified virtual object is not the target of an interaction.

In Step 111, the control unit 1 of the HMD 10 determines whether or not the virtual object 30 whose distance D1 between the user (head) and the virtual object 30 has not been determined remains. In the case where the virtual object 30 whose distance D1 has not been determined remains (YES in Step 111), the control unit 1 of the HMD 10 returns to Step 102, selects one virtual object 30 of the remaining virtual objects 30, and executes the processing of Step 103 and subsequent Steps.

Meanwhile, in the case where the determination of the distance D1 has been completed for all the virtual objects 30 (YES in Step 111), the control unit 1 of the HMD 10 determines whether or not the AR-displayed reminding UI 31 (the holding-over UI 31a and the imaging UI 31b) overlaps when viewed from the user (Step 112). In the case where the reminding UIs 31 (the holding-over UI 31a and the imaging UI 31b) overlap with each other (YES in Step 112), the control unit 1 of the HMD 10 adjusts the position of the reminding UI 31 such that the reminding UIs 31 do not overlap with each other (Step 113).

In the adjustment of the position of the reminding UI 31, the control unit 1 of the HMD 10 may move, for example, the reminding UI 31 present in the back, of the reminding UIs 31 overlapping with each other. Further, in the case where the virtual object 30 is an object such as a character that naturally autonomously moves, the control unit 1 of the HMD 10 may prevent the reminding UIs 31 from overlapping with each other by, for example, moving the corresponding reminding UI 31 while moving the object.

Here, the above-mentioned first threshold value Th1 is a threshold value for classifying the virtual object 30 into the holding-over-target object 30a and the imaging-target object 30b. This first threshold value Th1 is appropriately set in consideration of the reachable distance of the user holding the smartphone 20.

Further, the above-mentioned second threshold value Th2 is a threshold value for classifying the virtual object 30 into the imaging-target object 30b and the unclassified virtual object 30 (virtual object 30 that is not the target of an interaction). As this second threshold value Th2, a distance recognizable in the environment in the HMD 10, specifically, the longest distance that can be measured by the imaging unit 4 of the HMD 10, is used. As a result, it is possible to prevent an inappropriate virtual object 30 from being the target of an interaction when misrecognition occurs in the self-position estimation or the environment recognition and the distance D1 from the virtual object 30 is erroneously measured.

Further, since the longest distance actually measured changes in accordance with the surrounding environment such as the distance to a wall indoors and the distance to an outer wall of a building in an outdoor building district, the second threshold value Th2 may be changed in accordance with the longest distance determined by the environments.

Note that the first threshold value Th1 and the second threshold value Th2 may be changeable by the user by the user's customization.

[Interaction with the Smartphone 20]

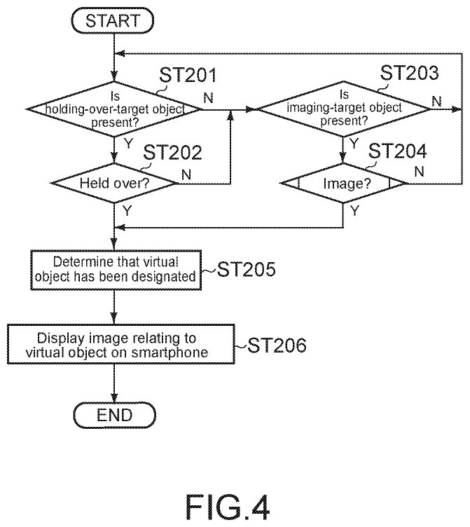

Next, the processing when a user has performed an interaction with regard to the virtual object 30 with the smartphone 20 will be described. FIG. 4 is a flowchart showing the processing when an interaction has been performed with regard to the virtual object 30. Note that the processing shown in FIG. 4 is executed by the control unit 21 of “the smartphone 20”.

In this embodiment, as interactions, two types of interactions of an operation of holding the smartphone 20 over the virtual object 30 (bringing the smartphone 20 closer to the virtual object 30) and an operation of imaging the virtual object 30 by the smartphone 20 are used. Note that as the interaction with regard to the virtual object 30, another method such as an operation of directing the smartphone 20 in the direction of the virtual object 30 may be used.

First, the control unit 21 of the smartphone 20 determines whether or not the holding-over-target object 30a is present (Step 201). Note that the smartphone 20 is notified of the presence of the holding-over-target object 30a from the HMD 10 (see Step 110 in FIG. 3).

In the case where the holding-over-target object 30a is present (YES in Step 201), the control unit 21 of the smartphone 20 determines whether or not the user has held the smartphone 20 over the holding-over-target object 30a (brought the smartphone 20 closer to the holding-over-target object 30a) (Step 202).

Regarding the determination of whether or not the smartphone 20 has been held over, first, the control unit 21 of the smartphone 20 determines, on the basis of the self-position of the smartphone 20 and the position of the holding-over-target object 30a, a distance D2 between the smartphone 20 and the holding-over-target object 30a. Note that the position of the holding-over-target object 30a is provided from the HMD 10 (see Step 110 in FIG. 3).

When determining the distance D2 between the smartphone 20 and the holding-over-target object 30a, the control unit 21 of the smartphone 20 determines whether or not this distance D2 is equal to or less than a third threshold value Th3 for a predetermined time T1 or longer. When this condition is satisfied, the control unit 21 of the smartphone 20 determines that the user has held the smartphone 20 over the holding-over-target object 30a. Meanwhile, in the case where this condition is not satisfied, the control unit 21 of the smartphone 20 determines that the user has not held the smartphone 20 over the holding-over-target object 30a.

If the predetermined time T1 is shortened, erroneous determination increases although the time required for the holding-over determination is shortened. Meanwhile, if the predetermined time T1 is lengthened, the time required for the determination becomes long although erroneous determination is reduced. As the predetermined time T1, an appropriate value is appropriately set in consideration of these matters.

Further, if the third threshold value Th3 is lengthened, erroneous determination increases although holding-over determination is performed even when the distance from the holding-over-target object 30a to the smartphone 20 is long. Meanwhile, if the third threshold value Th3 is shortened, the holding-over determination is not performed unless the smartphone 20 is brought closer to the holding-over-target object 30a although erroneous determination is reduced. As the third threshold value T3, an appropriate value is appropriately set in consideration of these matters. Note that the third threshold value Th3 may be as large as the radius of the sphere shown in FIG. 8.

Note that the predetermined time T1 and the third threshold value Th3 may be changed in accordance with the accuracy of the self-position estimation of the smartphone 20. For example, in the case where the smartphone 20 with high accuracy of self-position estimation is used, the predetermined time T1 and the third threshold value Th3 may be shortened. Conversely, in the case where the smartphone 20 with low accuracy of self-position estimation is used, the predetermined time T1 and the third threshold value Th3 may be lengthened.

Further, the predetermined time T1 and the third threshold value Th3 may be changeable by the user by the user's customization.

In Step 201, in the case where the holding-over-target object 30a is not present (NO in Step 201), the control unit 21 of the smartphone 20 proceeds to Step 203. Similarly, in the case where the smartphone 20 has not been held over the holding-over-target object 30a although the holding-over-target object 30a is present (NO in Step 202), the control unit 21 of the smartphone 20 proceeds to Step 203.

In Step 203, the control unit 21 of the smartphone 20 determines whether or not the imaging-target object 30b is present. Note that the smartphone 20 is notified of the presence of the imaging-target object 30b from the HMD 10 (see Step 110 in FIG. 3).

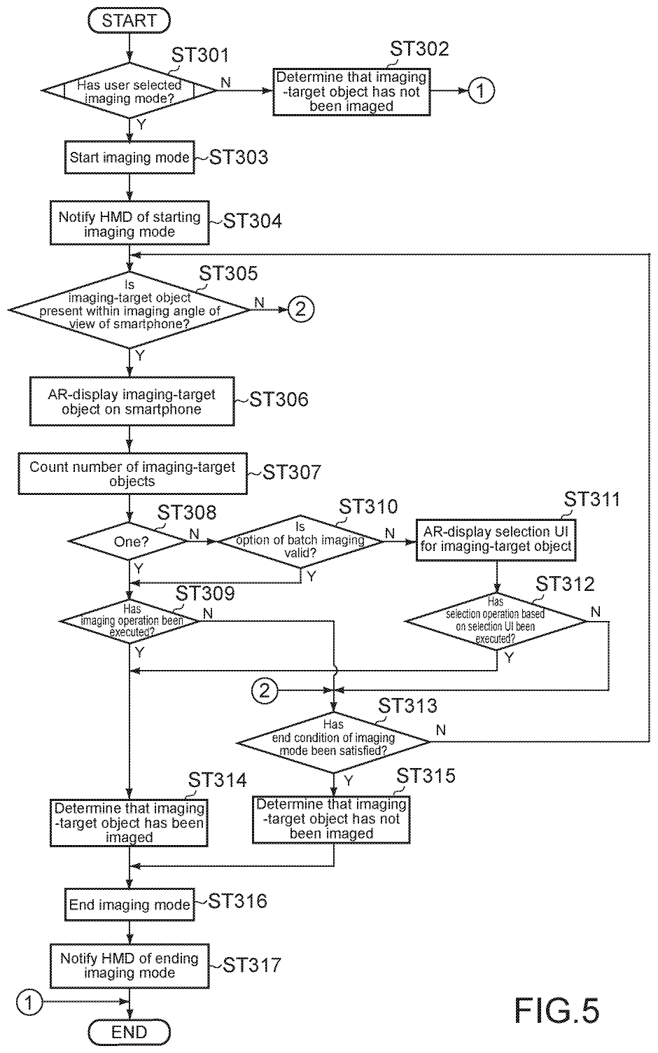

In the case where the imaging-target object 30b is present (YES in Step 203), the control unit 21 of the smartphone 20 determines whether or not the user has imaged the imaging-target object 30b by the smartphone 20 (Step 204). The determination of whether or not the imaging-target object 30b has been imaged will be described below in detail with reference to FIG. 5.

In the case where the imaging-target object 30b is not present (NO in Step 203), the control unit 21 of the smartphone 20 returns to Step 201. Similarly, in the case where the imaging-target object 30b has not been imaged by the smartphone 20 although the imaging-target object 30b is present (NO in Step 204), the control unit 21 of the smartphone 20 returns to Step 201.

In Step 202, in the case where the user has held the smartphone 20 over the holding-over-target object 30a (YES in Step 202), the control unit 21 of the smartphone 20 proceeds to Step 205. Similarly, in Step 204, in the case where the user has imaged the imaging-target object 30b by the smartphone 20 (YES in Step 204), the control unit 21 of the smartphone 20 proceeds to Step 205.

In Step 205, the control unit 21 of the smartphone 20 determines that the virtual object 30 has been designated by the user. Then, the control unit 21 of the smartphone 20 displays an image relating to the designated virtual object 30 on the display unit 23 of the smartphone 20 (Step 206).

Note that the phrase “display (an image relating to) the virtual object 30” on the smartphone 20 means that (an image relating to) the virtual object 30 is simply displayed on the display unit 23 of the smartphone 20 regardless of the real space.

The image relating to the virtual object 30 includes an image of the virtual object 30 itself, an image indicating related information of the virtual object 30, or a combination thereof. The related information of the virtual object 30 is, for example, the name, size, strength, attributes, and the like of a character in the case where the virtual object 30 is the character. The related information of the virtual object 30 may be any information as long as it is information relating to the virtual object 30.

The virtual object 30 may be editable by operating the image relating to the virtual object 30 by the user with the smartphone 20.

Here, in this embodiment, as will be described below, a plurality of the virtual objects 30 (imaging-target objects 30b) is simultaneously designated by batch imaging of the plurality of virtual objects 30 (see FIG. 5: YES in Step 310). In this case, for example, images relating to the plurality of designated virtual objects 30 are simultaneously displayed on the display unit 23 of the smartphone 20. Alternatively, images relating to the plurality of designated virtual object 30 are displayed in order for each of the virtual objects 30 with time.

Note that in this embodiment, the holding-over operation is detected as an interaction in the case where the distance D1 between the user and the virtual object 30 is equal to or less than the first threshold value Th1, and the imaging operation is detected as an interaction in the case where the distance D1 exceeds the first threshold value Th1. Meanwhile, the distance D1 between the user and the virtual object 30 is equal to or less than the first threshold value Th1, both the holding-over (bringing-closer) operation and the imaging operation may be detected as interactions.

In this case, the user can designate the virtual object 30 present within the reachable distance of the user by either the holding-over interaction or the imaging interaction.

In this case, as the reminding UI 31 on the HMD 10, both the holding-over UI 31a and the imaging UI 31b may be simultaneously AR-displayed or the holding-over UI 31a and the imaging UI 31b may be alternately switched with time.

[Determination of Whether or not Virtual Object 30 has been Imaged]

Next, determination of whether or not the virtual object 30 (imaging-target object 30b) has been imaged by the smartphone 20 will be described. That is, Step 204 in FIG. 4 will be described.

FIG. 5 is a flowchart showing the processing of determining whether or not the virtual object 30 (imaging-target object 30b) has been imaged by the smartphone 20. Note that the processing shown in FIG. 5 is executed by the control unit 21 of “the smartphone 20”.

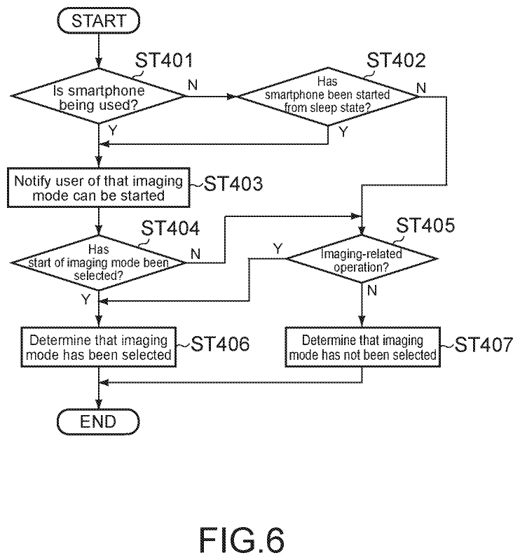

First, the control unit 21 of the smartphone 20 determines whether or not an imaging mode has been selected by a user (Step 301). The determination of whether or not an imaging mode has been selected will be described below in detail with reference to FIG. 6.

In the case where no imaging mode has been selected by a user (NO in Step 301), the control unit 21 of the smartphone 20 determines that the imaging-target object 30b has not been imaged by the user (Step 302). In this case, the determination in Step 204 in FIG. 4 is “NO”.

Meanwhile, in the case where an imaging mode has been selected by a user (YES in Step 301), the control unit 21 of the smartphone 20 displays, on the display unit 23 of the smartphone 20, an image taken by the imaging unit 26 of the smartphone 20 to start an imaging mode (Step 303).

Next, the control unit 21 of the smartphone 20 notifies the HMD 10 of starting an imaging mode (Step 304). Next, the control unit 21 of the smartphone 20 determines, on the basis of the self-position of the smartphone 20 and the position of the imaging-target object 30b, whether or not the imaging-target object 30b is present within the imaging angle of view of the imaging unit 26 of the smartphone 20 (Step 305). Note that the position of the imaging-target object 30b is provided from the HMD 10 (see Step 110 in FIG. 3).

In the case where the imaging-target object 30b is not present within the imaging angle of view (No in Step 305), the control unit 21 of the smartphone 20 proceeds to Step 313. Meanwhile, in the case where the imaging-target object 30b is present within the imaging angle of view (YES in Step 305), the control unit 21 of the smartphone 20 proceeds to the next Step 306.

In Step 306, the control unit 21 of the smartphone 20 AR-displays the imaging-target object 30b on the display unit 23 of the smartphone 20 (see also FIG. 9). Since the smartphone 20 uses the common coordinate system with the HMD 10, the control unit 21 of the smartphone 20 is capable of AR-displaying the imaging-target object 30b on the display unit 23 of the smartphone 20 without any deviation from the HMD 10.

Here, the phrase “AR-display the virtual object 30 (the imaging-target object 30b)” regarding the smartphone 20 means that an image obtained by superimposing the virtual object 30 on the image currently taken by the imaging unit 26 of the smartphone 20 is displayed on the display unit 23 of the smartphone 20, thereby making a user perceive the virtual object 30 as if it were a real object present in the real place (the same applies to the AR-display of a selection UI 32).

In this embodiment, regarding the smartphone 20, the term ““AR-display” the virtual object 30” and the term ““display” (an image relating to) the virtual object 30” are used with different meanings. Further, the term ““display” (an image relating to) the virtual object 30” is used, the meaning of ““AR-display” the virtual object 30” is not included.

Note that in this embodiment, only the imaging-target object 30b, of the three types of virtual object 30, i.e., the holding-over-target object 30a, the imaging-target object 30b, and the unclassified virtual object, is AR-displayed on the display unit 23 of the smartphone 20.

Meanwhile, in addition to the imaging-target object 30b, the holding-over-target object 30a or an unclassified virtual object 30 may be AR-displayed on the display unit 23 of the smartphone 20. However, in the case of AR-displaying only the imaging-target object 30b on the display unit 23 of the smartphone 20, a user can easily understand the imaging target, which is advantageous in this point.

When the imaging-target object 30b is AR-displayed on the display unit 23 of the smartphone 20, then, the control unit 21 of the smartphone 20 counts the number of the imaging-target objects 30b AR-displayed on the smartphone 20 (Step 307). Then, the control unit 21 of the smartphone 20 determines whether or not the number of the imaging-target objects 30b is one (Step 308).

In the case where the number of the imaging-target objects 30b AR-displayed on the smartphone 20 is two or more (NO in Step 308), the control unit 21 of the smartphone 20 determines whether or not the option of batch imaging of a plurality of imaging-target objects 30b is valid (Step 310). This option of batch imaging can be switched between valid and invalid by operating the smartphone 20 by a user, for example.

In the case where the number of the imaging-target objects 30b AR-displayed on the smartphone 20 is one (YES in Step 308), the control unit 21 of the smartphone 20 proceeds to Step 309. Similarly, in the case where the number of the imaging-target objects 30b AR-displayed on the smartphone 20 is two or more but the option of batch imaging is valid (YES in Step 310), the control unit 21 of the smartphone 20 proceeds to Step 309.

In Step 309, the control unit 21 of the smartphone 20 determines whether or not a user has executed an imaging operation of the imaging-target object 30b. The imaging operation by the user includes, for example, operating a shutter button displayed on the display unit 23 of the smartphone 20 by the user. Further, the imaging operation by the user includes operating (e.g., a tap operation) the imaging-target object 30b AR-displayed on the display unit 23 of the smartphone 20 by the user.

In Step 310, in the case where the option of batch imaging of the plurality of imaging-target objects 30b is invalid (NO in Step 310), the control unit 21 of the smartphone 20 proceeds to Step 311. In Step 311, the control unit 21 of the smartphone 20 AR-displays the selection UI 32 at the position corresponding to the imaging-target object 30b on the display unit 23 of the smartphone 20. The selection UI 32 is a UI for causing a user to select the imaging-target object 30b to be imaged from the plurality of imaging-target objects 30b.

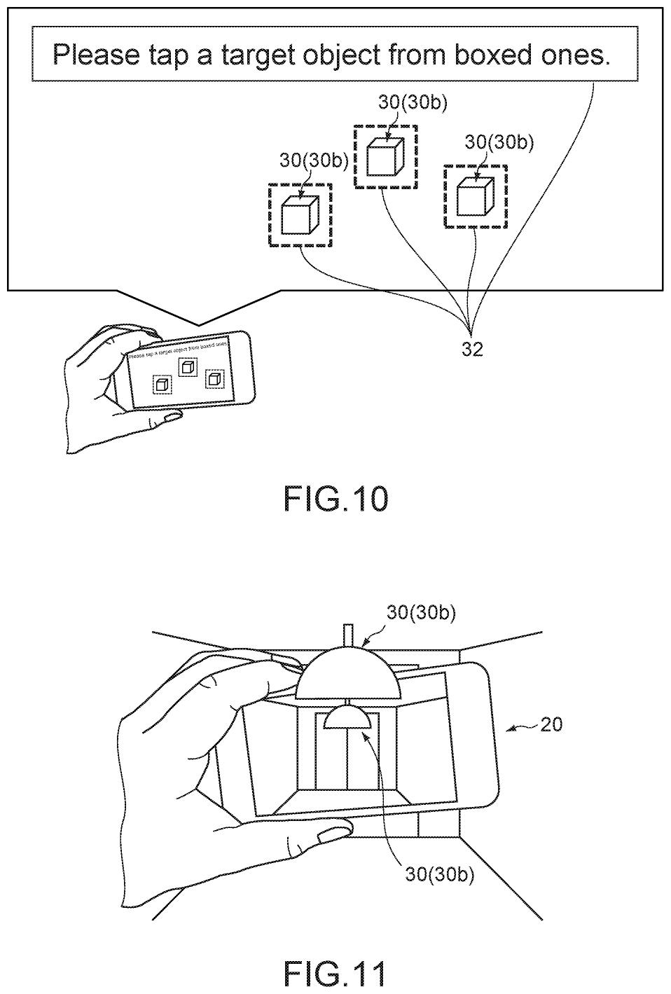

FIG. 10 is a diagram showing an example of the selection UI 32. In the examples shown in FIG. 10, an example in the case where a rectangle broken line surrounding the imaging-target object 30b is AR-displayed as the selection UI 32 for each of the three cubic imaging-target object 30b is shown. Further, in the example shown in FIG. 10, an example in the case where characters suggesting to select, by tapping, one from the imaging-target objects 30b surrounded by quadrangle broken lines are displayed on a display unit is shown.

Note that the selection UI 32 may be in any form as long as it is capable of suggesting to cause a user to select the imaging-target object 30b to be imaged from the plurality of imaging-target objects 30b.

Returning to FIG. 5, in Step 311, when the selection UI 32 is AR-displayed on the display unit 23 of the smartphone 20, the control unit 21 of the smartphone 20 proceeds to the next Step 312. In Step 312, the control unit 21 of the smartphone 20 determines whether or not a selection operation of the imaging-target object 30b based on the selection UI 32 has been executed by a user (Step). The selection operation of the imaging-target object 30b based on the selection UI 32 is, for example, an operation of tapping or touching a target on the display unit 23 of the smartphone 20, but various operations can be adopted as this selection operation.

In Step 309, in the case where an imaging operation of the imaging-target object 30b has been executed by a user (YES in Step 309), the control unit 21 of the smartphone 20 proceeds to Step 314. Similarly, in Step 312, in the case where the selection operation based on the selection UI 32 has been executed by a user (YES in Step 312), the control unit 21 of the smartphone 20 proceeds to Step 314.

In Step 314, the control unit 21 of the smartphone 20 determines that the imaging-target object 30b has been imaged by a user. In this case, the determination in Step 204 in FIG. 4 is “YES”.

In Step 309, in the case where an imaging operation of the imaging-target object 30b has not been executed by a user (NO in Step 309), the control unit 21 of the smartphone 20 proceeds to Step 313. Similarly, in Step 312, in the case where a selection operation based on the selection UI 32 has not been executed by a user (NO in Step 312), the control unit 21 of the smartphone 20 proceeds to Step 313. Note that also in the case where the imaging-target object 30b is not present within the imaging angle of view of the imaging unit 26 of the smartphone 20 as described above (NO in Step 305), the control unit 21 of the smartphone 20 proceeds to Step 313.

In Step 313, the control unit 21 of the smartphone 20 determines whether or not an end condition of the imaging mode has been satisfied. The end condition of the imaging mode includes a condition that a user has selected ending the imaging mode and a condition that a user has not operate the smartphone 20 for a predetermined time period, and it is determined, when one of the two conditions are satisfied, that the end condition has been satisfied.

In the case where the end condition of the imaging mode has not been satisfied (NO in Step 313), the control unit 21 of the smartphone 20 returns to Step 305 and executes the processing of Step 305 and subsequent Steps again.

Meanwhile, in the case where the end condition of the imaging mode has been satisfied (YES in Step 313), the control unit 21 of the smartphone 20 determines that the imaging-target object 30b has not been imaged by a user (Step 315). In this case, the determination in Step 204 in FIG. 4 is “NO”.

In Step 314, in the case where it is determined that the imaging-target object 30b has been imaged, the control unit 21 of the smartphone 20 proceeds to Step 316. Similarly, in Step 315, in the case where it is determined that the imaging-target object 30b has not been imaged, the control unit 21 of the smartphone 20 proceeds to Step 316.

In Step 316, the control unit 21 of the smartphone 20 ends the imaging mode by ending displaying, on the display unit 23 of the smartphone 20, the image taken by the imaging unit 26 of the smartphone 20. Then, the control unit 21 of the smartphone 20 notifies the HMD 10 of ending the imaging mode (Step 317) and ends the processing.

[Determination of Whether or not Imaging Mode has been Selected]

Next, determination of whether or not an imaging mode has been selected by a user will be described. That is, Step 301 in FIG. 5 will be described.

FIG. 6 is a flowchart showing the processing of determining whether or not an imaging mode has been selected by a user. Note that the processing shown in FIG. 6 is executed by the control unit of “the smartphone 20”.

First, the control unit 21 of the smartphone 20 determines whether or not the smartphone 20 is being used by a user (Step 401). In the case where the smartphone 20 is not being used (NO in Step 401), the control unit 21 of the smartphone 20 determines whether or not the smartphone 20 has been activated from the sleep state (Step 402).

In Step 401, in the case where the smartphone 20 is being used, the control unit 21 of the smartphone 20 proceeds to Step 403. Similarly, in Step 402, in the case where the smartphone 20 has been activated from the sleep state (YES in Step 402) (e.g., in the case where a user saw the reminding UI 31 of the HMD 10, took out the smartphone 20 from a pocket, and activated the smartphone 20 from the sleep state), the control unit 21 of the smartphone 20 proceeds to Step 403.

In Step 403, the control unit 21 of the smartphone 20 notifies a user of that the imaging mode can be started. Any method may be used as this notification method. Examples thereof include a method of displaying characters indicating that the imaging mode is possible on the display unit 23 of the smartphone 20 and a method of providing such notification by voice from a speaker.

When the notification that the imaging mode is possible is made, then, the control unit 21 of the smartphone 20 determines whether or not the start of an imaging mode has been selected by a user on the basis of the notification (Step 404). Any method can be used for the determination of whether or not the start of an imaging mode has been selected. Examples thereof include the following methods.

For example, the control unit 21 of the smartphone 20 displays, on the display unit 23 of the smartphone 20, a UI for selecting the start of an imaging mode and determines, on the basis of whether or not this UI has been operated (e.g., tapped) by a user, whether or not the start of an imaging mode has been selected. Further, for example, the control unit 21 of the smartphone 20 determines, on the basis of whether or not voice indicating that an imaging mode is started has been input from a user via a microphone, whether or not the start of an imaging mode has been selected.

In Step 402, in the case where the smartphone 20 has not been activated from the sleep state (NO in Step 402), the control unit 21 of the smartphone 20 proceeds to Step 405. Similarly, in Step 404, in the case where the start of an imaging mode has not been selected (NO in Step 404), the control unit 21 of the smartphone 20 proceeds to Step 405.

In Step 405, the control unit 21 of the smartphone 20 determines whether or not an imaging-related operation has been performed by a user. The imaging-related operation is, for example, an operation of directly activating the imaging unit 26 of a smartphone or an operation of directly pressing an imaging button (in the case where a mechanical imaging button is specially provided on the mobile device).

In Step 404, in the case where the start of an imaging mode has been selected by a user (YES in Step 404), the control unit 21 of the smartphone 20 proceeds to Step 406. Similarly, in Step 405, in the case where an imaging-related operation has been performed by a user (YES in Step 405), the control unit 21 of the smartphone 20 proceeds to Step 406.

In Step 406, the control unit 21 of the smartphone 20 determines that an imaging mode has been selected by a user. In this case, in Step 301 in FIG. 5, it is determined as “YES”.

In Step 405, in the case where an imaging-related operation has not been performed by a user (YES in Step 405), the control unit 21 of the smartphone 20 proceeds to Step 407.

In Step 407, the control unit 21 of the smartphone 20 determines that an imaging mode has not been selected by a user. In this case, in Step 301 in FIG. 5, it is determined as “NO”.

[Hide Control of Virtual Object 30]

Here, in this embodiment, hide control of the AR-display of the virtual object 30 by the HMD 10 is executed. First, the reason why this hide control is executed will be described.

In this embodiment, the virtual object 30 is AR-displayed on the display unit 3 of the HMD 10, and simultaneously, the virtual object 30 (the imaging-target object 30b) is AR-displayed also on the display unit 23 of the smartphone 20 in the imaging mode. In this case, if no measures are taken, the virtual object 30 AR-displayed by the HMD 10 and the virtual object 30 AR-displayed by the smartphone 20 appear to overlap with each other from the user's point of view and look unnatural in some cases.

FIG. 11 is a diagram showing an example in the case where the virtual object 30 AR-displayed by the HMD 10 and the virtual object 30 AR-displayed by the smartphone 20 look unnatural.

In the example shown in FIG. 11, the virtual object 30 of a pendant light is AR-displayed on the display unit 3 of the HMD 10. Simultaneously, in the imaging mode, the virtual object 30 of a pendant light is AR-displayed on the display unit 23 of the smartphone 20.

Of the display unit 3 of the HMD 10 and the display unit 23 of the smartphone 20, the display unit 3 of the HMD 10 is present on the front side from the user's point of view. For this reason, the virtual object 30 of a pendant light AR-displayed by the HMD 10 looks to be on the front side of the virtual object 30 AR-displayed by the smartphone 20 from the user's point of view, resulting in unnatural looking.

In this embodiment, in order to AR-display the virtual object 30 in a way that is natural for the user, control for hiding the virtual object 30 in the display unit 3 of the HMD 10 as necessary is executed.

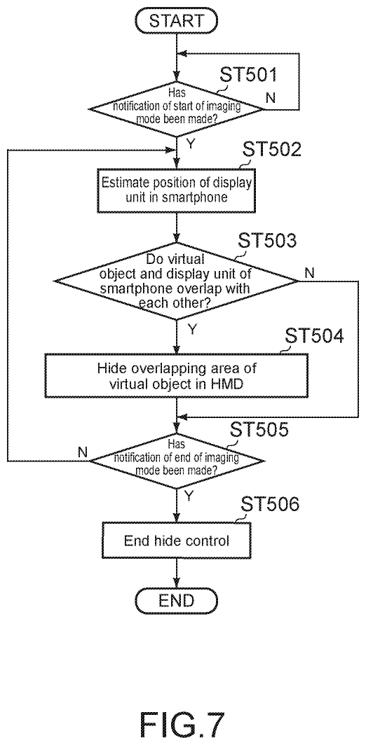

FIG. 7 is a flowchart showing the processing when the virtual object 30 is hidden as necessary in the HMD 10. Note that the processing shown in FIG. 7 is executed by the control unit 1 of “the HMD 10”.

As shown in FIG. 7, first, the control unit 1 of the HMD 10 determines whether or not notification of the start of an imaging mode has been made from the smartphone 20 (Step 501). Note that in the smartphone 20, when the imaging mode is started, notification of the start of an imaging mode is made from the smartphone 20 (Step 304 in FIG. 5).

Next, the control unit 1 of the HMD 10 estimates, on the basis of the self-position of the HMD 10 and the position of the smartphone 20, the relative position of the display unit 23 in the smartphone 20 relative to the HMD 10 (Step 502). Note that in this embodiment, since the above-mentioned common coordinate system is used, the control unit 1 of the HMD 10 is capable of accurately determining the position of the display unit 23 of the smartphone 20.

Next, the control unit 1 of the HMD 10 determines whether or not the display area of the virtual object 30 (the imaging-target object 30b) AR-displayed by the HMD 10 and the display unit 23 of the smartphone 20 overlap with each other when viewed from the user (Step 503).

In the case where the display area of the virtual object 30 and the display unit 23 of the smartphone 20 overlap with each other (YES in Step 503), the control unit 1 of the HMD 10 hides the overlapping area of the virtual object 30 in the display unit 3 of the HMD 10 (Step 504).

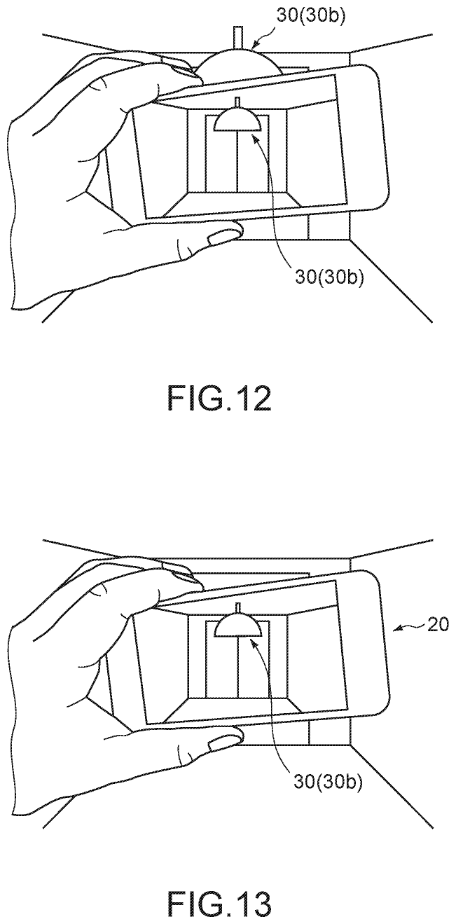

FIG. 12 is a diagram showing an example in the case where the overlapping area between the virtual object 30 and the display unit 23 of the smartphone 20 has been hidden in the display unit 3 of the HMD 10. In the example shown in FIG. 12, part on the lower side of the pendant light AR-displayed on the display unit 3 of the HMD 10 overlaps with the display unit 23 of the smartphone 20. For this reason, part on the lower side of the pendant light is partially hidden in the HMD 10.

Returning to FIG. 7, when the processing of hiding the overlapping area of the virtual object 30 is executed, then, the control unit 1 of the HMD 10 returns to Step 505. Similarly, in Step 503, in the case where the display area of the virtual object 30 and the display unit 23 of the smartphone 20 dot not overlap with each other (NO in Step 503), the control unit 1 of the HMD 10 proceeds to Step 505.

In Step 505, the control unit 1 of the HMD 10 determines whether or not notification of the end of an imaging mode has been made from the smartphone 20. Note that when the imaging mode is ended in the smartphone 20, notification of the end of the imaging mode is made from the smartphone 20 (see Step 317 in FIG. 5).

In the case where notification of the end of an imaging mode has not been made from the smartphone 20 (NO in Step 505), the control unit 1 of the HMD 10 returns to Step 502 and estimates the position of the display unit 23 of the smartphone 20 again. Meanwhile, in the case where notification of the end of an imaging mode has been made from the smartphone 20 (YES in Step 505), the control unit 1 of the HMD 10 ends the hide control of the virtual object 30 to perform normal AR-display (Step 506) and ends the processing.

In the description here, in the imaging mode, the case where when the display area of the virtual object 30 AR-displayed on the display unit 3 of the HMD 10 overlaps with the display unit 23 of the smartphone 20, the virtual object 30 is hidden in the overlapping area has been described. Meanwhile, in the imaging mode, when the display area of the virtual object 30 AR-displayed on the display unit 3 of the HMD 10 overlaps with the display unit 23 of the smartphone 20, the entire corresponding virtual object 30 may be hidden.

FIG. 13 is a diagram showing an example in the case where the entire virtual object 30 overlapping with the display unit 23 of the smartphone 20 has been hidden in the imaging mode. In the example shown in FIG. 13, a case where since part on the lower side of the pendant light AR-displayed on the HMD 10 overlaps with the display unit 23 of the smartphone 20, the entire pendant light is hidden in the imaging mode is shown.

<Effects, Etc.>

As described above, in this embodiment, the virtual object 30 is AR-displayed on the display unit 3 of the HMD 10, an interaction of a user on the virtual object 30 with the smartphone 20 (interaction device) is detected, and an image relating to the virtual object 30 is displayed on the display unit 23 of the smartphone 20 in accordance with the interaction.

As a result, in this embodiment, when the user wearing the HMD 10 is interested in the virtual object 30 and performs an interaction on the virtual object 30 with the smartphone 20, an image relating to the virtual object 30 is displayed on the smartphone 20. Then, the user can acquire information regarding the virtual object 30 by looking at the image of the virtual object 30 displayed on the smartphone 20.

Therefore, when the user is interested in the virtual object 30, he/she does not need to stay there and keep looking at the virtual object 30 by the HMD 10. Further, at present, the smartphone 20 often has a higher resolution than the HMD 10, and therefore, it can be said to be suitable for taking a closer look at the virtual object 30 that the user is interested in.

Further, in this embodiment, the operation of bringing the smartphone 20 closer to the virtual object 30, particularly, the holding-over operation is detected as an interaction. Here, at present, the operation of holding the smartphone 20 over something is an operation generally used for payment of fares in public transportation and payment by shopping. For this reason, also the operation of holding the smartphone 20 over the virtual object 30 is thought to be a natural interaction for a user and therefore, such a holding-over interaction is thought to be naturally accepted by a user without discomfort.

Further, in this embodiment, an operation of imaging, by the imaging unit 26 of the smartphone 20, the virtual object 30 AR-displayed on the display unit 23 of the smartphone 20 is detected as an interaction. At present, an operation of imaging a real object (building, person, QR code, etc.) of interest with the smartphone 20 is a commonly used operation. For this reason, also the operation imaging the virtual object 30 with the smartphone 20 is thought to be a natural interaction for a user and therefore, such an imaging interaction is thought to be naturally accepted by a user without discomfort.

Here, as a comparison, assumption is made that a user performs an interaction of directly touching, by hand, the virtual object 30 AR-displayed by the HMD 10. The virtual object 30 is often AR-displayed in a place without physical clues such as in the air. Therefore, in this case, there is a problem that it is difficult for a user to perform a physical interaction such as directly touching the virtual object 30. Further, in the case of this method, since determination of an interaction by hand recognition cannot be performed if a hand is not captured within the imaging angle of view of the imaging unit 4 of the HMD 10, the range in which an interaction can be performed is limited.

Meanwhile, in this embodiment, since the smartphone 20 is held by the hand and held over the virtual object 30, there is an advantage that an interaction is relatively easily performed as compared with the case of directly touching the virtual object 30 by hand. Further, in this embodiment, since the virtual object 30 is imaged with the smartphone 20, there is an advantage that an interaction is easily performed as compared with the case of directly touching the virtual object 30 by hand. Further, in this embodiment, it is unnecessary to capture a hand within the imaging angle of view of the imaging unit 4 of the HMD 10, and therefore, the range in which an interaction can be performed is less limited.

Further, in this embodiment, an interaction is changed in accordance with the distance D1 between the user wearing the HMD 10 and the AR-displayed virtual object 30. As a result, it is possible to appropriately change the interaction in accordance with the distance D1.

Further, in this embodiment, in the case where the distance D1 between the user and the virtual object 30 is equal to or less than the first threshold value Th1, the holding-over operation (bringing-closer operation) is detected as an interaction. Meanwhile, in the case where the distance D1 between the user and the virtual object 30 exceeds the first threshold value Th1, the imaging operation is detected as an interaction.

As a result, the holding-over operation is used as an interaction when the virtual object 30 is within the reachable distance from a user, and the imaging operation is used as an interaction when the virtual object 30 is not within the reachable distance from a user. As described above, in this embodiment, it is possible to appropriately change the interaction in accordance with the distance D1 between the user and the virtual object 30.

Further, in the case where the distance D1 between the user and the virtual object 30 is equal to or less than the first threshold value Th1, both the holding-over (bringing-close) operation and the imaging operation can be detected as interactions. In this case, a user can designate, by either the holding-over interaction or the imaging interaction, the virtual object 30 present within the reachable distance from the user.

Further, in this embodiment, the reminding UI 31 reminding a user of an interaction is AR-displayed at the position corresponding to the virtual object 30 in the display unit 3 of the HMD 10. As a result, the user can easily recognize, by visually recognizing the reminding UI 31, that an interaction can be performed and what interaction should be performed.

Further, in this embodiment, in the case where a plurality of reminding user UIs is AR-displayed on the display unit 3 of the HMD 10 and the display area of the reminding UI 31 overlaps with the display area of another reminding UI 31, the AR display position of the reminding UI 31 is adjusted. As a result, it is possible to present the reminding UI 31 to a user in an easy-to-see manner.

Further, in this embodiment, in the imaging mode, in the case where the display area of the virtual object 30 AR-displayed on the display unit 3 of the HMD 10 overlaps with the display unit 23 of the smartphone 20, the virtual object 30 is hidden in the area overlapping with the display unit 23 of the smartphone 20. As a result, it is possible to prevent the virtual object 30 AR-displayed on the HMD 10 from looking to be on the front side of the virtual object 30 AR-displayed by the smartphone 20, resulting in unnatural looking.

Further, in the imaging mode, in the case where the display area of the virtual object 30 AR-displayed on the display unit 3 of the HMD 10 overlaps with the display unit 23 of the smartphone 20, the entire corresponding virtual object 30 can be hidden. Also in this form, similarly, such unnatural looking can be prevented. Further, a user can concentrate on imaging the virtual object 30 with the smartphone 20.

Further, in the case of this form, since it is unnecessary to accurately determine the overlapping area between the virtual object 30 of the HMD 10 and the display unit 23 of the smartphone 20 in the HMD 10, it is possible to reduce the processing load. Further, in the case of this form, it is also effective when the relative positional relationship between the HMD 10 and the smartphone 20 cannot be accurately measured and the overlapping area cannot be accurately estimated (while in this embodiment, since the above-mentioned common coordinate system is used, the overlapping area can be accurately determined).

Further, in this embodiment, in the imaging mode, in the case where a plurality of virtual objects 30 is AR-displayed on the display unit 23 of the smartphone 20, the selection UI 32 for causing a user to select the virtual object 30 to be imaged is AR-displayed on the display unit 23 of the smartphone 20. As a result, the user can easily select, by the selection operation based on the selection UI 32, an arbitrary virtual object 30 from the plurality of virtual objects 30, and it is possible to prevent a selection error from occurring.

### Various Modified Examples

In the above description, the case where the virtual object 30 actually AR-displayed on the display unit 3 of the HMD 10 is the target of an interaction of the smartphone 20 has been described (see Step 101 to Step 111). Meanwhile, the virtual object 30 that can be AR-displayed on the HMD 10 (e.g., the virtual object 30 present within a certain distance from the HMD 10) because it is present around the HMD 10 may be a target of an interaction of the smartphone 20, regardless of whether or not the display unit 3 of the HMD 10 is actually AR-displayed.

In this case, for example, a user can designate the virtual object 30 by holding the smartphone 20 over the virtual object 30 (bringing the smartphone 20 closer to the virtual object 30) without looking in the direction of the virtual object 30 with the HMD 10. Further, in this case, even if the user is not looking in the direction of the virtual object 30 with the HMD 10, the virtual object 30 is AR-displayed on the smartphone 20 when the smartphone 20 is directed in the direction of the virtual object 30, and the user can designate the virtual object 30 by imaging the virtual object 30.

In the above description, the smartphone 20 has been described as an example of an interaction device for a user to perform an interaction. Meanwhile, the interaction device is not limited to the smartphone 20. Typically, the interaction device only needs to be a mobile device that can be held by the user or a wearable device that can be worn by a hand or an arm of the user.

Examples of the mobile device that can be held by a user include a mobile phone other than the smartphone 20, a tablet PC (Personal Computer), a portable game console, and a portable music player. Examples of the wearable device that can be worn by a hand or an arm of a user include wristwatch type (wristband type), ring type, and glove type wearable devices.

In the above description, the case where the control unit 1 of the HMD 10 executes the processing shown in FIG. 3 and FIG. 7 and the control unit 21 of an interaction device executes the processing shown in FIG. 4 to FIG. 6 has been described. Meanwhile, the processing shown in FIG. 3 to FIG. 7 may be executed by one of the control unit 1 of the HMD 10 and the control unit 21 of an interaction device.

As an example, a case where the processing shown in FIG. 3 is executed by the control unit 21 of an interaction device will be described. In this case, first, the control unit 21 of an interaction device receives image information in the imaging unit 4 of the HMD 10 from the HMD 10 to recognize the surrounding environment of the HMD 10 and instructs, on the basis of the environment recognition result, the HMD 10 to AR-display the virtual object 30 on the display unit 3 of the HMD 10 (Step 101).

Next, the control unit 21 of an interaction device selects one virtual object 30 (Step 102) and calculates the distance D1 between the user (head) and the virtual object 30 (Step 103). Regarding the position of a user necessary for calculating the distance D1, for example, information regarding the self-position estimated by the HMD 10 is acquired from the HMD 10 and the control unit 21 of an interaction device obtains the position of the user on the basis of this information.

Next, the control unit 21 of an interaction device compares the distance D1 between the user and the virtual object 30 with the first threshold value Th1 and the second threshold value Th2 to determine the classification of the virtual object 30 (Step 104 and Step 107). Then, the interaction device instructs the HMD 10 to AR-display the corresponding reminding UI 31 for each classification (Step 106 and Step 109).

Then, the control unit 21 of an interaction device executes processing such as calculation of the distance D1 and classification on all the virtual objects 30 (YES in Step 111), and instructs, in the case where the reminding UIs 31 overlap with each other (YES in Step 112), the HMD 10 to adjust the position of the reminding UI 31 (Step 113).

Further, as an example, a case where the processing shown in FIG. 4 is executed by the control unit 1 of the HMD 10 will be described. In this case, first, the control unit 1 of the HMD 10 determines, in the case where the holding-over-target object 30a is present (YES in Step 201), whether or not a user has held an interaction device over the holding-over-target object 30a (Step 202). In this case, since the position information of the smartphone 20 is necessary, the control unit 1 of the HMD 10 only needs to acquire the information of the self-position estimated by the smartphone 20 from the smartphone 20.

Further, the control unit 1 of the HMD 10 determines, in the case where the imaging-target object 30b is present (YES in Step 203), whether or not a user has imaged the imaging-target object 30b with an interaction device (Step 204). In this case, since information regarding the imaging operation of the user with the interaction device is necessary, the control unit 1 of the HMD 10 only needs to acquire the information regarding the imaging operation from the smartphone 20.

In the case where the holding-over interaction or the imaging interaction (YES in Step 202 and YES in Step 204), the control unit 1 of the HMD 10 determines that the virtual object 30 has been designated (Step 205). Then, the control unit 1 of the HMD 10 instructs the smartphone 20 to display an image relating to the virtual object 30 on the display unit 23 of the smartphone 20 (Step 206).

Further, the processing shown in FIG. 3 to FIG. 7 may be executed not by a head-mounted display or an interaction device but by a control unit of an external device capable of communicating with these devices. Examples of this external device include various PCs such as a desktop PC and a laptop PC, and a server apparatus on a network.

Here, the “information processing apparatus” means an apparatus including a control unit that executes various types of processing shown in FIG. 3 to FIG. 7 and the like. For this reason, in the case where a head-mounted display executes all of the main processing, the head-mounted display alone can be regarded as one information processing apparatus. Similarly, in the case where an interaction device executes all of the main processing, the interaction device alone can be also regarded as one information processing apparatus. Similarly, an external device such as a server apparatus on a network executes all of the main processing, also the external device alone can be regarded as one information processing apparatus.

Further, in the case where at least two or more devices of the head-mounted display, the interaction device, and the external device share and execute the processing, the entire system including the two or more devices that share and execute the processing can be regarded as one information processing apparatus. Note that in the above-mentioned first embodiment, the head-mounted display and the interaction device (smartphone 20) share and execute the processing, and therefore, the entire information processing system 100 including these two devices is regarded as one information processing apparatus in the first embodiment.

The present technology may also take the following configurations.

(1) An information processing apparatus, including:

a control unit that causes a first display unit of a head-mounted display to display a virtual object in an AR (Augmented Reality) manner, detects a user interaction with regard to the virtual object, the interaction being performed with an interaction device, and causes a second display unit of the interaction device to display an image relating to the virtual object in accordance with the interaction.

(2) The information processing apparatus according to (1) above, in which

the interaction device includes an imaging unit, and

the control unit AR-displays the virtual object on the second display unit and detects, as the interaction, an operation of imaging the AR-displayed virtual object by the imaging unit.

(3) The information processing apparatus according to (2) above, in which

the control unit detects, as the interaction, an operation of bringing the interaction device closer to the virtual object. (4) The information processing apparatus according to (3) above, in which the operation of bringing is an operation of holding the interaction device over the virtual object.

(5) The information processing apparatus according to (3) or (4) above, in which

the control unit changes the interaction in accordance with a distance between a user wearing the head-mounted display and the AR-displayed virtual object.

(6) The information processing apparatus according to (5) above, in which

the control unit detects, where the distance between the user and the virtual object exceeds a predetermined threshold value, the operation of imaging as the interaction.

(7) The information processing apparatus according to (6) above, in which

the control unit detects, where the distance between the user and the virtual object is the predetermined threshold value or less, the operation of bringing as the interaction.

(8) The information processing apparatus according to (6) above, in which

the control unit detects, where the distance between the user and the virtual object is the predetermined threshold value or less, both the operation of bringing and the operation of imaging as the interaction.

(9) The information processing apparatus according to any one of (1) to (8) above, in which

the control unit AR-displays a reminding user interface for reminding the user of the interaction at a position corresponding to the virtual object in the first display unit.

(10) The information processing apparatus according to (9) above, in which

the control unit adjusts, where a plurality of the reminding user interfaces is AR-displayed on the first display unit and a display area of the reminding user interface overlaps with a display area of another reminding user interface, the AR-display position of the reminding user interface.

(11) The information processing apparatus according to (2) above, in which

the control unit hides, where a display area of the virtual object AR-displayed on the first display unit overlaps with the second display unit, the virtual object in an area overlapping with the second display unit.

(12) The information processing apparatus according to (2) above, in which

the control unit hides, where a display area of the virtual object AR-displayed on the first display unit overlaps with the second display unit, an entire corresponding virtual object.

(13) The information processing apparatus according to (2) above, in which

the control unit causes, where a plurality of the virtual objects has been AR-displayed on the second display unit, the second display unit to AR-display a selection user interface for causing the user to select a virtual object to be imaged.

(14) The information processing apparatus according to any one of (1) to (13) above, in which

the interaction device is a mobile device that can be held by the user or a wearable device that can be worn by a hand or an arm of the user.

(15) An information processing method, including:

causing a first display unit of a head-mounted display to AR-display a virtual object;

detecting a user interaction with regard to the virtual object, the interaction being performed with an interaction device; and

causing a second display unit of the interaction device to display an image relating to the virtual object in accordance with the interaction.

(16) A program that causes a computer to execute the following processing of:

causing a first display unit of a head-mounted display to AR-display a virtual object;

detecting a user interaction with regard to the virtual object, the interaction being performed with an interaction device; and

causing a second display unit of the interaction device to display an image relating to the virtual object in accordance with the interaction.

### REFERENCE SIGNS LIST

1, 21 control unit
2, 22 storage unit
3, 23 display unit
4, 24 imaging unit
5, 25 inertia sensor
6, 16 operation unit
7, 27 communication unit
10 HMD
20 smartphone
30 virtual object
31 reminding UI
32 selection UI
100 information processing system

1. An information processing apparatus, comprising:
a control unit that causes a first display unit of a head-mounted display to display a virtual object in an AR manner, detects a user interaction with regard to the virtual object, the interaction being performed with an interaction device, and causes a second display unit of the interaction device to display an image relating to the virtual object in accordance with the interaction.

2. The information processing apparatus according to claim 1, wherein
the interaction device includes an imaging unit, and
the control unit AR-displays the virtual object on the second display unit and detects, as the interaction, an operation of imaging the AR-displayed virtual object by the imaging unit.

3. The information processing apparatus according to claim 2, wherein
the control unit detects, as the interaction, an operation of bringing the interaction device closer to the virtual object.

4. The information processing apparatus according to claim 3, wherein
the operation of bringing is an operation of holding the interaction device over the virtual object.

5. The information processing apparatus according to claim 3, wherein
the control unit changes the interaction in accordance with a distance between a user wearing the head-mounted display and the AR-displayed virtual object.

6. The information processing apparatus according to claim 5, wherein
the control unit detects, where the distance between the user and the virtual object exceeds a predetermined threshold value, the operation of imaging as the interaction.

7. The information processing apparatus according to claim 6, wherein
the control unit detects, where the distance between the user and the virtual object is the predetermined threshold value or less, the operation of bringing as the interaction.

8. The information processing apparatus according to claim 6, wherein
the control unit detects, where the distance between the user and the virtual object is the predetermined threshold value or less, both the operation of bringing and the operation of imaging as the interaction.

9. The information processing apparatus according to claim 1, wherein
the control unit AR-displays a reminding user interface for reminding the user of the interaction at a position corresponding to the virtual object in the first display unit.

10. The information processing apparatus according to claim 9, wherein
the control unit adjusts, where a plurality of the reminding user interfaces is AR-displayed on the first display unit and a display area of the reminding user interface overlaps with a display area of another reminding user interface, the AR-display position of the reminding user interface.

11. The information processing apparatus according to claim 2, wherein
the control unit hides, where a display area of the virtual object AR-displayed on the first display unit overlaps with the second display unit, the virtual object in an area overlapping with the second display unit.

12. The information processing apparatus according to claim 2, wherein
the control unit hides, where a display area of the virtual object AR-displayed on the first display unit overlaps with the second display unit, an entire corresponding virtual object.

13. The information processing apparatus according to claim 2, wherein
the control unit causes, where a plurality of the virtual objects has been AR-displayed on the second display unit, the second display unit to AR-display a selection user interface for causing the user to select a virtual object to be imaged.

14. The information processing apparatus according to claim 1, wherein
the interaction device is a mobile device that can be held by the user or a wearable device that can be worn by a hand or an arm of the user.

15. An information processing method, comprising:
causing a first display unit of a head-mounted display to AR-display a virtual object;
detecting a user interaction with regard to the virtual object, the interaction being performed with an interaction device; and
causing a second display unit of the interaction device to display an image relating to the virtual object in accordance with the interaction.

16. A program that causes a computer to execute the following processing of:
causing a first display unit of a head-mounted display to AR-display a virtual object;
detecting a user interaction with regard to the virtual object, the interaction being performed with an interaction device; and
causing a second display unit of the interaction device to display an image relating to the virtual object in accordance with the interaction.
